(19) United States
(12) Patent Application Publication
(10) Pub. No.: US 2019/0171779 A1
(43) Pub. Date: Jun. 6, 2019

(54) ROOM PLANNING SYSTEM AND METHOD

(71) Applicant: The West Retail Group Limited, North Yorkshire (GB)

(72) Inventor: Malcolm Healey, North Yorkshire (GB)

(21) Appl. No.: 16/199,640

(22) Filed: Nov. 26, 2018

(30) Foreign Application Priority Data
Nov. 24, 2017 (GB) 1719518.1

(51) Int. Cl. G06F 17/50

(52) U.S. Cl. CPC G06F 17/5004

(57) ABSTRACT

A method 100, of adjusting component sizes in a room-space plan, comprises the steps of creating a room-space plan, having a boundary, inserting objects into the room-space plan, adjusting the layout boundary and modifying the size of one or more of the inserted objects, wherein the step of modification is applied only to objects which interact with at least a part of the adjusted boundary.

The present invention relates to apparatus and methods for planning a room and is concerned particularly, although not exclusively, with apparatus and methods for planning a kitchen.

### BACKGROUND

The process of designing a kitchen includes making selections of several different types of component often from a great number of options. The process also involves the specification of a room layout using other structural element components including walls, room fixtures, such as doors, windows, boiler units and utility inlets.

There are several factors which limit the ways in which such component can be combined, most importantly, the physical space. The layout will limit and/or modify component positions and features.

Historically, the planning stage involved manually selecting the style and type of component, and then manually determining compatibility, making calculations as necessary. A sketch was produced at the end of the process to visualise the finished design.

More recently the process has become computerised, with a database of components being accessed by a designer who specifies items for inclusion in the kitchen, whereupon a processor builds a virtual model of the kitchen

A problem with this is that the most efficient use of material components is not necessarily achieved.

Certain adjustments to the virtual model may result in knock-on consequences in the materials and components required.

For example, the alteration of or addition of a unit may change the required number, shape and or size of the end panels, therefore requiring further components to be added to the order. Efficient management of order components will aid in the reduction of wasted materials.

Accordingly, the present invention aims to provide an apparatus and method of planning a room and managing component use in which the abovementioned disadvantages are at least partly overcome.

### STATEMENTS OF INVENTION

The present invention is defined in the attached independent claims, to which reference should now be made. Further, preferred features may be found in the sub-claims appended thereto.

According to a first aspect of the present invention, there is provided a method of planning a room space including, arranging a plurality of components for cutting, the method comprising the steps of determining one or more component locations in a room-space layout; determining a cut position relative to a standard component portion having a standard size value, to leave a remnant portion and a component portion, such that the size of the component portion and the remnant portion add up to the standard size value; and amending the cut position upon adjustment of the room-space; wherein, adjustments are made automatically to the remnant portion and the component portion.

The component may be an end panel or filler piece.

Preferably, the method comprises the step of determining the existence and/or size of an exposed side of a unit and arranging an end panel relative to the standard component portion so as to minimise the size of the remnant portion.

According to a second aspect of the invention, there is provided a room-space design system for enabling a user to design a room-space from a plurality of design options, and for displaying an image of the design, the system comprising at least one host processor comprising a design unit; wherein the design unit is arranged in use to specify an component portion having an component portion size value (CP), derived from a standard component having a standard component size value (SC) to leave a remnant having a remnant size value (R), and wherein the component portion size value and the remnant size value add up to the standard component size value, such that an amendment to the component portion size value is automatically made to the remnant size value.

Preferably, further component portions are specified from the remnant, such that further component portion size values are CP1, CP2, CP3 and so on, the remnant size value R is automatically amended to maintain the relationship (CP1+CP2+CP3+ . . . )+R=SC.

The component may be an end panel or a filler piece.

The room-space design system may be arranged to communicate with a sales system such that amendments made to a design are automatically made in the sales system.

Preferably, the room-space design system is arranged to determine a need for, and automatically add one or more end panels based on the layout of components inserted into the room-space.

Optionally, the room-space design system may be arranged to notify a user upon removal of an automatically added end panel.

The room-space design system may be arranged to determine a need for, and automatically insert, a filler panel when a component is positioned in a pre-determined location.

The predetermined location may be when the component is positioned between 0 m and 0.015 m, more preferably 0.013 m of a wall of the room-space.

According to a third aspect of the invention, there is provided a method of adjusting component sizes in a room-space plan, the method comprising the steps of creating a room-space plan, having a boundary; inserting objects into the room-space plan; adjusting the layout boundary, and modifying the size of one or more of the inserted objects; wherein, the step of modification is applied only to objects which interact with at least a part of the adjusted boundary.

The objects may be any of the following but not limited to: interior wall portions, cable/pipe covering portions, doors, windows, utility inlets, appliances, and/or furniture.

The invention also comprises a program for causing a device to perform a method according to any statement herein.

The invention also comprises a computer programme product for performing a method according to any statement herein.

The invention may include any combination of the features or limitations referred to herein, except such a combination of features as are mutually exclusive, or mutually inconsistent.

### BRIEF DESCRIPTION OF THE FIGURES

A preferred embodiment of the present invention will now be described. By way of example only, with reference to the accompanying diagrammatic drawings, in which:

FIG. 1 shows a flowchart of a method for the addition of end panels to a room-space design according to an embodiment of the invention;

FIG. 2 shows a first exemplary room-space design layout;

FIG. 3 shows a partial top-down view of a second exemplary room-space design layout;

FIG. 4 shows a flowchart of a method for the adjustment and/or removal of components after adjusting a room-space design layout.

### Specific Description

The present invention provides a system and method for room planning. A computer terminal, advantageously based in or close to a showroom or sales office, allows a user to create a design of a room space, and then to select from articles to be installed in the room space. The selections are made from a database, which may be located remotely, and regular reference is made to the database to ensure that stock lists are up to date, for example, to ensure that items are not specified that are unavailable.

When designing a room-space, there are a number of different components available for a user to select, and the combinations of these options result in a large number of permutations of design. Some components may require the addition of decor end panels, for example, kitchen units. These decor end panels have standard sizes, however, these standard sizes may not be suitable for all arrangements of the components chosen by the user. Therefore, in order to minimise cost and reduce wastage, it is important to accurately and efficiently manage the use of these standard size end panel portions.

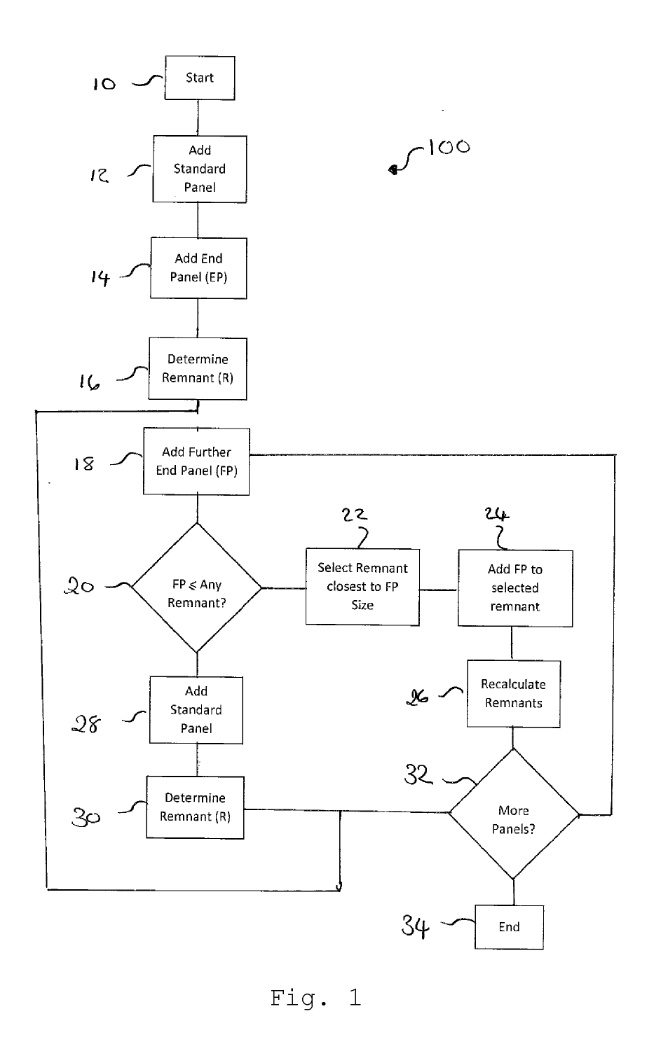

FIG. 1 shows a flowchart of a method 100 of accurately managing the use of the standard end panel portions so as to reduce wastage for any user-created design.

The method starts at 10, and a standard panel is added at step 12. The standard panel's dimensions are stored in a system so that the system can efficiently allocate user defined end panels to be cut from the standard panel. The user will then add a component to the design, for example, a kitchen unit. The method then progresses to step 14, where the system determines the necessary end panel or end panels required for the added component. The system allocates a portion of the standard panel to be used as the required panel, and also determines the amount of the standard panel left over (the remnant) at step 16.

The method then progresses to step 32, where it is determined whether further end panels are required, for example, if two end panels are required for the initial component, or whether subsequent components have been added to the design. If additional end panels are required, the method progresses to step 18, if not the method progresses to step 34 where the method ends.

At step 18, a further end panel is added to the design. The method then progresses to step 20, where it is determined whether the further end panel is less than or equal to any remnant portions. This enables the system to efficiently arrange the required end panels so that a minimum number of standard panels are used. If the further end panel is less than or equal to the size of one or more of the remnants, the method progresses to step 22. If not the method progresses to step 28.

At step 22, if there is more than one remnant currently available, the method selects the remnant with the size closest to that of the required further end panel, thus reducing the wastage. Once selected, the method progresses to step 24, where the required end panel is allocated to that remnant and the method then progresses to step 26. At step 26, the remaining remnant sizes are recalculated. This includes the remaining portion of the remnant used for the required further end panel. The method then progresses to step 32.

At step 28, if the further end panel is larger than any of the remnants, a new standard panel is added, and the further end panel is allocated to a portion of the standard panel. The method then progresses to step 30 where the remnant is determined which is stored for potential use for other end panels. The method then progresses to step 32.

At step 32, it is determined whether any further end panels are required. If so the method loops back to step 18, and if not, the method progresses to step 34 where the method terminates.

Whilst the above method relates to a single design and the efficient usage of materials for that design, it is appreciated that the method may be used by a plurality of users creating a plurality of designs, so as to efficiently manage end panel production over a number of designs, further reducing wastage.

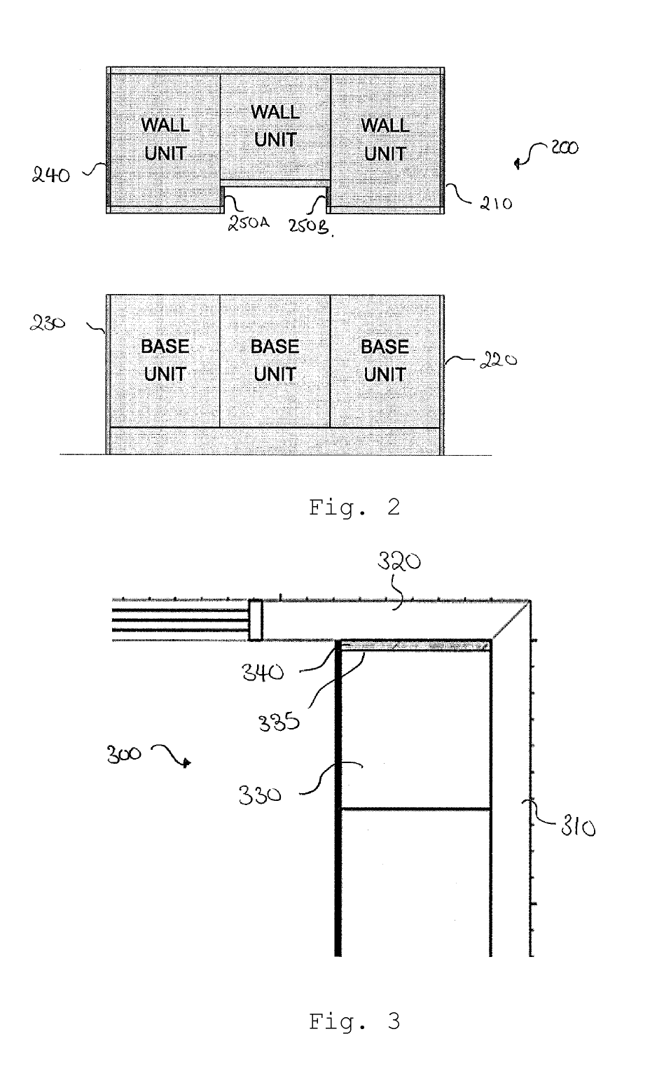

FIG. 2 shows an exemplary design which may be created by a user and where efficient end panel allocations would reduce costs to the end user. In FIG. 2 a user has laid out a series of three base units and three wall units. The base unit run and the wall unit run both have exposed ends which require decor end panels. For example, a base unit and a standard wall unit may be 0.6 m high and a reduced height wall unit may be 0.4 m high, whereas a standard end panel may be 1.2 m high. Following the method of FIG. 1, a first standard panel will be added at step 12, and the first end panel 210, extending the full height of one of the wall units, will be allocated to the first standard panel. The method will then progress to step 16 where the remnant is determined. In this case, the remnant will be 0.6 m.

The method would then progress to step 32 where it will be determined that more end panels are required. The method will then progress to step 18 where a second end panel 220 of 0.6 m will be added to the design. At step 20, this will be checked against any remnants to see if it is less than or equal to any of the remnant portions available for use. In this case, the remnant of 0.6 m from the first standard panel would be suitable, therefore this is selected at step 22, and the method progresses to step 24. At step 24, as the remnant size is the second end panel, the recalculated value at step 26 is 0.0 m.

The method then progresses to step 32 again, where it is determined more end panels are required. The method will progress to step 18 where a third end panel 230 of 0.6 m high will be added to the design. At step 20, it will be determined that there are no remnants capable of being cut to the size of the third end panel 230. Therefore, the method will progress to step 28, where a second standard panel will be added. The third end panel 230 will be allocated to the second standard panel and the method will progress to step 30, where the remnant will be determined at 0.6 m. The method will again progress to step 32 where it will be determined that a fourth end panel 240 is required. The method will loop back through steps 18, 20, 22, 24, and 26 using the remnant from the second standard panel for the fourth end panel 240. After which the method will again arrive at step 32.

As the wall unit run comprises two standard height units on either side of a reduced height unit, it will be determined that a fifth end panel 250A of 0.2 m will be required, and the method will loop back to step 18. At step 20 it will be determined that there are no remnants remaining, so the method will progress to step 28. At step 28 a third standard panel will be added, and the fifth end panel 250A will be allocated to the third standard panel. At step 30, the method will determine that the remnant portion is 1.0 m. The method will then progress to step 32 again where it will be determined that a sixth end panel 250B of 0.2 m is required. The method will loop back to step 18 where the sixth end panel will be added. It will be determined at step 20 that the sixth end panel 250B may be allocated to the third standard panel's remnant, which will be selected at step 22, and then added to that remnant at step 24. The method will then progress to step 26 where the remnant will be recalculated to 0.8 m. The method will finally progress to step 32 where it will be determined that no further panels are required and the method will terminate at step 34.

The remaining remnant of 0.8 m will remain available for use should the user modify the design, at which point the method will restart, and the calculations will be repeated.

It will be appreciated that the numbers used in the above example are merely exemplary, and other unit heights and standard end panel sizes may be used.

In some embodiments, a user may be able to manually edit, add and even remove the remnants calculated by the method. This may cause a warning to be generated, which may inform the user, customer and installer that the editing and/or removal of the remnant may result in a particular surface being unfinished when the units have been assembled.

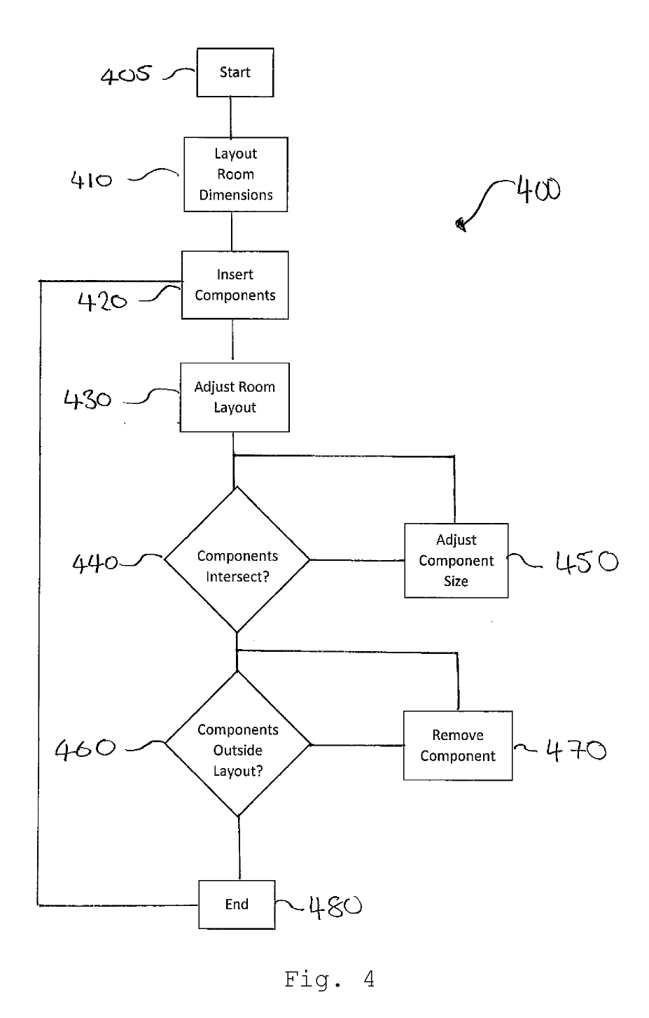

FIG. 3 shows part of a top down view of a room-space design with a plurality of components, such as kitchen units. Specifically, FIG. 3 shows two walls 310, 320 meeting at right angles, and a kitchen unit 330 resting against a first wall 310 and ending very close to the second wall 320. Normally, it would be determined that an end panel needs to be placed on the exposed edge 335 closest to wall 320. However, due to the close proximity of the wall 320 to the exposed edge 335, this would result in a less than desirable finish. Therefore, if it is determined that the edge 335 of a component 330 is less than or equal to a predetermined distance away from a wall 320, instead of an end panel, a decorative filler piece 340 can be inserted. As with decor end panels, the filler pieces are manufactured in standard sizes, and therefore, the method of FIG. 1 may be used to efficiently manage the use of the standard filler pieces so as to reduce cost and wastage.

FIG. 4 shows a flowchart of a method 400 of adjusting components upon the changing of room-space dimensions in which they are placed.

The method starts at step 405, where a user provides a room-space layout. The user then provides the necessary dimensions for the room-space, which includes, but is not limited to, wall length, wall height, and wall thickness. It can also include the positions and sizes of appliances, windows, doors.

At step 420, the user then inserts a number of components, such as kitchen units, trunking for pipework and/or cables, and other room fixtures, such as radiators.

In some cases, the user will be satisfied with the layout of the room-space and the method will progress to step 480 where it terminates. In other situations, the user may wish to amend the room-space layout, for example by adjusting wall sizes (widths, heights, depths), or by moving fixtures such as doors. Here the method will notify the user of changes, and in some embodiments, they will be asked to provide adjusted measurements where these cannot be calculated automatically.

As a result of the modifications to the room-space layout, a number of the components which have been inserted into the room-space design may need altering in order to be viable in the real world. For example, the adjusting the wall height and/or width will have an effect on trunking for cables/pipes, and may also affect the positioning of items such as wall units, as well as the size and/or requirement for other components such as decor end panels and filler pieces.

The method will then progress to step 440, where it will be determined whether any of the components intersect with the adjusted room-space layout, for example, if a kitchen unit bisects a wall, or if an existing pipe/cable trunking extends above the height of the ceiling. If there is at least one component which meets these criteria, the method will progress to step 450, where the component's size is adjusted, where possible, such that it no longer intersects the adjusted room-space layout. Steps 440 and 450 are then repeated until all intersecting components have been adjusted. Where a component's size cannot be adjusted, for example, due to the component having a minimum size and/or fixed size, the user will be informed of this and be asked to manually modify the layout to take into account the adjustments made.

Once all intersecting components have been adjusted, the method will progress to step 460, where components that were inside the room-space layout prior to the adjustment but are now outside the room-space layout are determined. This may occur, for example, due to moving the position of a wall. If one or more of the components are determined to be placed outside the room-space layout, the method progresses to step 470, where the component is removed. The method repeats steps 460 and 470 until all outlying components have been removed. Once this is the case, the method progresses to step 480 where it terminates.

It will be appreciated that steps 440 and 450, and steps 460 and 470, may be done in the opposite order. That is, the method may determine which components are outside the adjusted layout first, and then progress to adjusting component sizes if it is determined that any components intersect the adjusted layout.

In some embodiments, a user may be able to manually edit, add and even remove the filler portions calculated by the method. This will case a warning to be generated, which informs the user, customer and installer that the editing and/or removal of the filler portion may result in a gap being visible when the units have been assembled.

Once the component sizes have been adjusted, the design system may proceed to recalculate the required end panel portions and filler pieces as described above in relation to the method of FIG. 1, so as to drive efficiency and reduce costs even further.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

1. A method of planning a room space, including arranging a plurality of components for cutting, the method comprising the steps of:
determining one or more component locations in a room-space layout;
determining a cut position relative to a standard component portion having a standard size value, to leave a remnant portion and a component portion, such that the size of the component portion and the remnant portion add up to the standard size value; and
amending the cut position upon adjustment of the room-space;
wherein, adjustments are made automatically to the remnant portion and the component portion.

2. The method of claim 1, wherein the component is an end panel or filler piece.

3. The method of claim 1, further comprising the step of determining the existence and/or size of an exposed side of a unit and arranging an end panel relative to the standard component portion so as to minimise the size of the remnant portion.

4. A room-space design system for enabling a user to design a room-space from a plurality of design options, and for displaying an image of the design, the system comprising at least one host processor comprising a design unit;
wherein the design unit is arranged in use to specify an component portion having an component portion size value (CP), derived from a standard component having a standard component size value (SC) to leave a remnant having a remnant size value (R), and wherein the component portion size value and the remnant size value add up to the standard component size value, such that an amendment to the component portion size value is automatically made to the remnant size value.

5. The room-space design system of claim 4, wherein further component portions are specified from the remnant, such that further component portion size values are CP1, CP2, CP3 and so on, the remnant size value R is automatically amended to maintain the relationship (CP1+CP2+CP3+ . . . )+R=SC.

6. The room-space design system of claim 4, wherein the component is an end panel or a filler piece.

7. The room-space design system of claim 4 arranged to communicate with a sales system such that amendments made to a design are automatically made in the sales system.

8. The room-space design system of claim 4 arranged to determine a need for, and automatically add one or more end panels based on the layout of components inserted into the room-space.

9. The room-space design system of claim 4 arranged to notify a user upon removal of an automatically added end panel.

10. The room-space design system of claim 4 arranged to determine a need for, and automatically insert, a filler panel when a component is positioned in a pre-determined location.

11. The room-space design system of claim 10, wherein the predetermined location is between 0 m and 0.015 m, more preferably 0.013 m of a wall of the room-space.

12. A method of adjusting component sizes in a room-space plan, the method comprising the steps of:
creating a room-space plan, having a boundary;
inserting objects into the room-space plan;
adjusting the layout boundary; and
modifying the size of one or more of the inserted objects;
wherein, the step of modification is applied only to objects which interact with at least a part of the adjusted boundary.

13. The method of claim 12, wherein the objects are any of: an interior wall portions, a cable/pipe covering portion, a door, a window, utility inlets, appliances, and/or furniture.

14. An apparatus comprising a processor and a memory having therein computer readable instructions, the processor being arranged in used to read the instructions to cause the performance of a method of arranging a plurality of components for cutting, the method comprising the steps of:
determining one or more component locations in a room-space layout;
determining a cut position relative to standard component portion having a standard size value, to leave a remnant portion and a component portion, such that the size of the component portion and the remnant portion add up to the standard size value; and
amending the cut position upon adjustment of the room-space;
wherein, adjustments are made automatically to the remnant portion and the component portion.

15. An apparatus comprising a processor and a memory having therein computer readable instructions, the processor being arranged in used to read the instructions to cause the performance of a method of adjusting component sizes in a room-space plan, the method comprising the steps of:
creating a room-space plan, having a boundary;
inserting objects into the room-space plan;
adjusting the layout boundary; and
modifying the size of one or more of the inserted objects;
wherein, the step of modification is applied only to objects which interact with at least a part of the adjusted boundary.

16-17. (canceled)

18. A computer program product on a non-transitory computer readable storage medium, comprising computer readable instructions that, when executed by a computer, cause the computer to perform a method according to claim 1.

19. A computer program product on a non-transitory computer readable storage medium, comprising computer readable instructions that, when executed by a computer, cause the computer to perform a method according to claim 12.
